(19) United States
(12) Patent Application Publication
(10) Pub. No.: US 2024/0185281 A1
(43) Pub. Date: Jun. 6, 2024

(54) OPTIMIZING PHYSICAL COMMERCE CHANNELS FOR UNCERTAIN EVENTS

(71) Applicant: INTERNATIONAL BUSINESS MACHINES CORPORATION, ARMONK, NY (US)

(72) Inventors: William Bruce Nicol, II, Durham, NC (US); Lakshminarayanan Srinivasan, Cary, NC (US); Peter Yim, Raleigh, NC (US); John Handy Bosma, Leander, TX (US)

(21) Appl. No.: 18/062,079

(22) Filed: Dec. 6, 2022

(51) Int. Cl. G06Q 30/0207; G06Q 30/0211; G06Q 30/0235

(52) U.S. Cl. CPC G06Q 30/0223; G06Q 30/0211; G06Q 30/0235

(57) ABSTRACT

A method, computer system, and a computer program product for store optimization is provided. The present invention may include monitoring a plurality of consumers for a physical store. The present invention may include receiving an alert. The present invention may include determining one or more incentives to offer the plurality of consumers based on the alert. The present invention may include applying the one or more incentives to a product inventor of the physical store.

### BACKGROUND

The present invention relates generally to the field of computing, and more particularly to data driven physical commerce channels.

Physical commerce channels may refer to brick and mortar stores, retail stores, in-person stores, amongst other physical locations which may be engaged in commerce. In the past, these physical commerce channels may have aimed to maximize the number of consumers within their store and/or an amount of time these consumers spent within their store. However, prior to and/or during uncertain events, such as, but not limited to, historical weather events, pandemics, seasonal infectious diseases, amongst other uncertain events these physical commerce channels may have difficulty efficiently operating their business. Physical commerce channels may be disadvantaged in comparison to E-commerce channels during these uncertain events when it comes to at least, monitoring inventory, optimizing store capacity, and/or customer safety.

Accordingly, physical commerce channels may require a computer-implemented solution to enable efficient management of commerce during these uncertain events.

### SUMMARY

Embodiments of the present invention disclose a method, computer system, and a computer program product for store optimization. The present invention may include monitoring a plurality of consumers for a physical store. The present invention may include receiving an alert. The present invention may include determining one or more incentives to offer the plurality of consumers based on the alert. The present invention may include applying the one or more incentives to a product inventor of the physical store.

In another embodiment, the method may include monitoring an effectiveness of the one or more incentives on the plurality of consumers.

In a further embodiment, the method may include retraining a machine learning model based on the effectiveness of the one or more incentives on the plurality of consumers.

In addition to a method, additional embodiments are directed to a computer system and a computer program product for optimizing store capacity, profitability and customer safety during an uncertain event.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE SEVERAL VIEWS OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 depicts a block diagram of an exemplary computing environment according to at least one embodiment; and

FIG. 2 is an operational flowchart illustrating a process for store optimization according to at least one embodiment.

### DETAILED DESCRIPTION

The following described exemplary embodiments provide a system, method and program product for store optimization. As such, the present embodiment has the capacity to improve the technical field of physical commerce channels by optimizing store capacity, profitability and customer safety during an uncertain event. More specifically, the present invention may include monitoring a plurality of consumers for a physical store. The present invention may include receiving an alert. The present invention may include determining one or more incentives to offer the plurality of consumers based on the alert. The present invention may include applying the one or more incentives to a product inventor of the physical store.

As described previously, physical commerce channels may refer to brick and mortar stores, retail stores, in-person stores, amongst other physical locations which may be engaged in commerce. In the past, these physical commerce channels may have aimed to maximize the number of consumers within their store and/or an amount of time these consumers spent within their store. However, prior to and/or during uncertain events, such as, but not limited to, historical weather events, pandemics, seasonal infectious diseases, amongst other uncertain events these physical commerce channels may have difficulty efficiently operating their business. Physical commerce channels may be disadvantaged in comparison to E-commerce channels during these uncertain events when it comes to at least, monitoring inventory, optimizing store capacity, and/or customer safety.

Accordingly, physical commerce channels may require a computer-implemented solution to enable efficient management of commerce during these uncertain events.

Therefore, it may be advantageous to, among other things, monitor a plurality of consumers for a physical store, receive an alert, determine one or more incentives to offer the plurality of consumers based on the alert, and apply the one or more incentives to a product inventory of the physical store.

According to at least one embodiment, the present invention may improve customer safety my determining recommendations based on a set of rules associated with an uncertain event which may adhere to local, state, and/or federal guidelines and/or restrictions.

According to at least one embodiment, the present invention may improve store profitability during uncertain events by applying one or more incentives associated with elapsed time within the store to product inventory.

According to at least one embodiment, the present invention may improve the ability of store owners to control the physical population of a store based on the number of consumers within the store, potential consumers outside the store, and current regulations and/or rules.

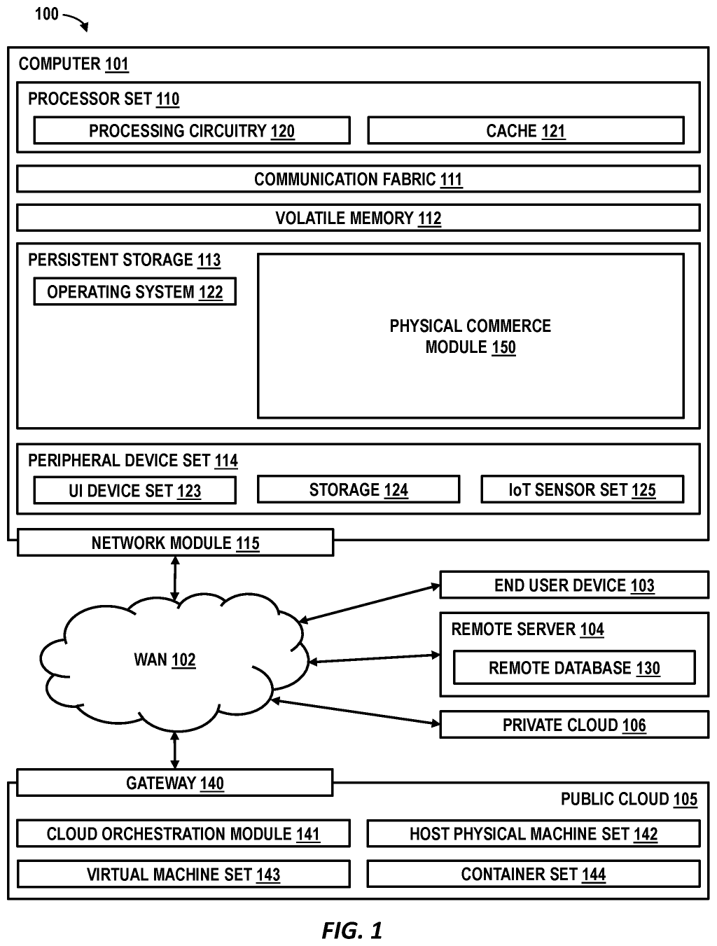

Referring to FIG. 1, Computing environment 100 contains an example of an environment for the execution of at least some of the computer code involved in performing the inventive methods, such as optimizing store capacity, profitability and customer safety during an uncertain event using the physical commerce module 150. In addition to block 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor Set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

Communication fabric 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent Storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 150 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End User Device (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economics of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

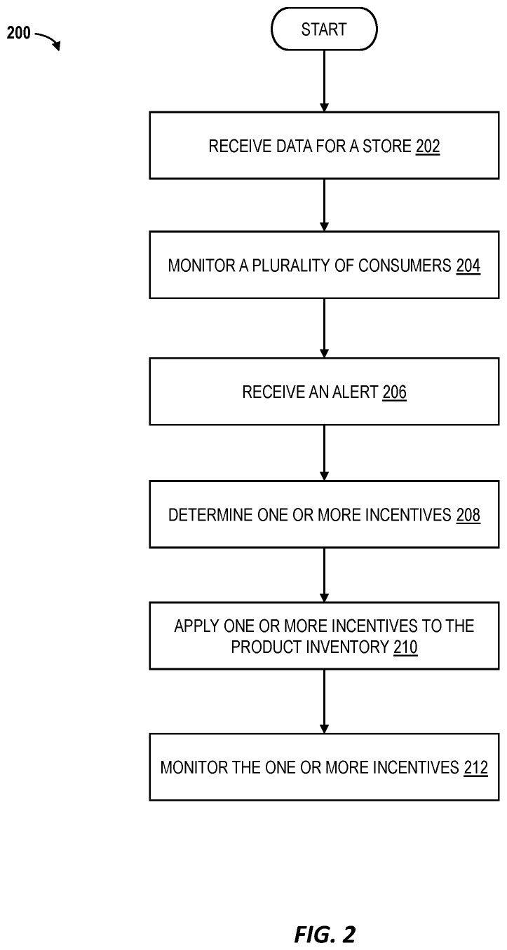

According to the present embodiment, the computer environment 100 may use the physical commerce module 150 to enhance safety and efficiency according of physical stores during uncertain events. The store optimization method is explained in more detail below with respect to FIG. 2.

Referring now to FIG. 2, an operational flowchart illustrating the exemplary store optimization process 200 used by the physical commerce module 150 according to at least one embodiment is depicted.

At 202, the physical commerce module 150 receives data for a physical store. The physical commerce module 150 may collect data for the physical store from a plurality of sources. The physical commerce module 150 may collect data for the physical store such as, but not limited to, physical attributes of the store, product inventory, consumer data, amongst other data for the physical store.

Physical attributes of the store may include, but are not limited to including, square footage, property size, location, blueprints, entrance locations, exit locations, aisles, shelves, store capacity, amongst other physical attributes of the store. The physical attributes of the store may be received from an authorized user associated with the physical store (e.g., manager, owner, employee) directly and/or from one or more IoT devices associated with the physical store. The physical commerce module 150 may receive the physical attributes directly from the authorized user in a user interface. The physical commerce module 150 may display a user interface to a user on an EUD 103, UI device set 123 of the peripheral device set 114, and/or another device in at least an internet browser, dedicated software application, and/or as an integration with a third party software application. The one or more IoT devices associated with the physical store may capture images, video, and/or 3D scans of the physical store such that the physical attributes of the store may received by the physical commerce module 150. The physical attributes of the physical store may be stored in the database 130 (e.g., knowledge corpus). The physical commerce module 150 may utilize the data collected for the physical store including at least the physical attributes in generating a digital twin of the physical store. A digital twin may be a digital representation of at least an object, entity and/or system that spans the object, entity, and/or system's lifecycle. As will be explained in more detail below, the digital twin of the physical store may be updated using real time data, and may utilize, at least, simulation, machine learning, and/or reasoning in aiding informed decision making.

Product inventory may include a list of products offered for sale by the physical store. The physical commerce module 150 may collect data on the product inventory from at least the one or more IoT devices associated with the physical store, such as, but not limited to, IoT refrigerators (e.g., smart refrigerator), IoT shelves (e.g., smart shelves), amongst other methods of utilizing smart technology in monitoring product inventory. The physical commerce module 150 may also collect data on the product inventory directly from the authorized user within the user interface and/or access to inventory management software which may be integrated with the user interface. As will be explained in more detail below with respect to step 206 at least a portion of the product inventory may be designated as essential items. The physical commerce module 150 may store one or more lists of essential items in the database 130 (e.g., knowledge corpus). As will be explained below, each of the one or more lists of essential items may correspond to an uncertain event.

Consumer data may include, transaction records, items purchased, number of sales for different time frames, consumer tracking, amongst other consumer data. The physical commerce module 150 may collect consumer data from consumers directly and/or indirectly. The physical commerce module 150 may collect data from consumers directly using data received from one or more smart wearable devices associated with a consumer, one or more IoT devices associated with the consumer, Global Positioning Systems (GPS) of the one or more smart wearable devices and/or IoT devices, integrated third party applications utilized by the consumer, amongst other consumer data sources. The consumer data collected by the physical commerce module 150 shall not be construed as to violate or encourage the violation of any local, state, federal, or international law with respect to privacy protection. The physical commerce module 150 may receive consent from consumers prior to receiving consumer data. The physical commerce module 150 may further require periodic consent with respect to any consumer data collected. The consumer may revoke data collection from the physical commerce module 150 at any time and/or may disconnect the one or more IoT devices associated with the consumer at any time.

At 204, the physical commerce module 150 monitors a plurality of consumers. The physical commerce module 150 may monitor the plurality of consumers both inside and outside of the physical store.

The physical commerce module 150 may monitor the plurality of consumers using images, thermal imagery, and/or video feed from one or more IoT devices inside and/or outside the physical store, the consumer data received at step 202, and/or one or more scanners placed at the entrances and/or exits of the physical store in morning the plurality of consumers. The one or more scanners places at the entrances and/or exits of the physical store may include, but are not limited to including, bar code scanners, RFID (Radio Frequency Identification) scanners, QR code scanners, amongst other scanners consumers may utilize. As will be explained in more detail below, the physical commerce module 150 may monitor the plurality of consumers entering and/or exiting the physical store in at least maintaining a count for the number of consumers in the physical store at any given time. Additionally, each of those consumers may be associated with a time stamp based on the time the consumer entered the physical store. All consumer monitoring performed by the physical commerce module 150 shall not be construed as to violate or encourage the violation of any local, state, federal, or international law with respect to privacy protection.

As will be explained in more detail below, the physical commerce module 150 may also monitor the plurality of consumers outside the physical store. The physical commerce module 150 may monitor the plurality of consumers outside the physical store in determining one or more incentives to offer in store consumers.

At 206, the physical commerce module 150 receives an alert. The alert received by the physical commerce module 150 may be related to one or more uncertain events. The one or more uncertain events may include, but are not limited to including, historical weather events, pandemics, seasonal infectious diseases, amongst other uncertain events.

The physical commerce module 150 may receive the alert automatically and/or manually. The physical commerce module 150 may receive the alert automatically through integration with a third party service and/or monitoring of one or more publicly available resources. The physical commerce module 150 may utilize at least a web-crawler and/or other content moderating techniques such as those implemented in in IBM Watson® (IBM Watson and all Watson-based trademarks are trademarks or registered trademarks of International Business Machines Corporation in the United States, and/or other countries), IBM Watson® Speech to Text, IBM Watson® Tone Analyzer, IBM Watson® Natural Language Understanding. IBM Watson® Natural Language Classifier, amongst other search mechanisms in automatically monitoring alerts which may impact the store. The physical commerce module 150 may also receive the alert manually from an authorized user within the user interface.

Each alert received by the physical commerce module 150 may be associated with one or more sets of rules. The one or more sets of rules may include, but are not limited to including, store capacity, social distancing, essential items, curfews, amongst other rules and/or guidelines which may be associated with the alert received. The one or more sets of rules may be predetermined and/or may be based on local, state, and/or federal restrictions and/or guidelines.

The one or more sets of rules may be predetermined by an authorized user within the user interface. In the embodiment in which the one or more sets of rules may be predetermined by the user, the one or more sets of rules may be stored in the database 130 (e.g., knowledge corpus). For example, the physical commerce module 150 may receive an alert about a hurricane approaching the area. According to the one or more lists of essential items stored in the database 130 (e.g., knowledge corpus) the physical commerce module 150 may determine one or more incentives such that consumers are incentivized to shop at the physical store in a responsible manner.

In another embodiment, the one or more sets of rules may be based on federal guidelines. In this embodiment the physical commerce module 150 may utilize the search mechanisms described above in extracting the one or more sets of rules from the federal guidelines. In this embodiment, the physical commerce module 150 may determine the one or more incentives such that the physical store may operate efficiently in adherence with the federal guidelines.

At 208, the physical commerce module 150 determines one or more incentives. The physical commerce module 150 may determine the one or more incentives based on at least the one or more sets of ruled associated with the alert received, the one or more lists of essential items corresponding to the one or more uncertain events, and/or the time stamp, associated with each of the plurality of consumers in the physical store, amongst other information.

The physical commerce module 150 may utilize one or more machine learning models in determining the one or more incentives to offer the plurality of consumers. The physical commerce module 150 may utilize the one or more machine learning models in determining the one or more incentives based on at least the one or more sets of ruled associated with the alert received, the one or more lists of essential items corresponding to the one or more uncertain events, and/or the time stamp, associated with each of the plurality of consumers in the physical store, amongst other information. As will be described in more detail in at least step 212, the physical commerce module 150 may utilize data gathered from monitoring the one or more incentives in retraining the one or more machine learning models based on the data associated with the one or more incentives in the database 130 (e.g., knowledge corpus). For example, the alert received at step 206 may include federal restrictions with respect to the number of consumers allowed to be in the physical store at a given time. The physical commerce module 150 may utilize the data with respect to the plurality of consumers received at step 204 in determining the number of consumers in the physical store and waiting outside the physical store.

The physical commerce module 150, utilizing the one or more machine learning models, may leverage the time stamp associated with the consumer entering the physical store in determining incentives that may vary according to an elapsed time spent in the physical store such that discounts may decrease the more time the consumer occupies the physical store. For example, the physical commerce module 150 may utilize a tiered discount model determined using the one or more machine learning models based on at least, the store capacity under the one or more sets of rules, the number of consumers within the physical store, and the number of consumers waiting outside the physical store. In this example the physical commerce module 150 may determine an incentive of a 10% discount for consumers in the store for less than 10 minutes, a 5% discount for consumers in the store for less than 20 minutes, and no discount for consumers in the store for greater than 20 minutes. As will be explained in more detail below with respect to at least step 212, the physical commerce module 150 may utilize data received in determine at least an effectiveness of each incentive which may be utilized by the one or more machine learning models in at least adjusting the tiered discount model applied to the product inventory.

The physical commerce module 150 may present the one or more incentives to the plurality of consumers through a plurality of mediums, such as, but not limited to, in-store visual displays, the one or more IoT devices and/or smart wearable devices associated with the consumer described at step 202, through Augmented Reality (AR), and/or through tags of the product inventory. The product inventory may be affixed with a tag, such as, but not limited to, an RFID tag, barcode tag, QR (Quick Response) code tag, UPC (Universal Product Code) tag, 1D (1 Dimensional) barcodes, 2D (2 Dimensional) barcodes, different types of labels, amongst others. The tag may contain a variety of information with respect to the tagged product, such as, but not limited to, the one or more incentives associated with the product determined by the physical commerce module 150. For example, the alert received at step 206 may be for an incoming storm or other weather event. An authorized user may have predetermined a set of rules for inclement weather which may correspond to a specific list of essential items. In this example, the consumer may scan a tag on product of the essential items list and the physical commerce module 150 may display a cost structure disincentivizing the consumer from purchasing more than a predetermined amount of an essential items.

In an embodiment, the physical commerce module 150 may personalize the one or more incentives offered to a consumer based on consumer specific data received at step 202. For example, the physical commerce module 150 may adjust the incentives associated with the elapsed time in a physical store for certain consumers, offer home delivery, and/or provide specific recommendations of products the consumer may want to purchase based on at least the consumer specific data received at step 202 and the alert received at step 206.

At 210, the physical commerce module 150 applies the one or more incentives to the product inventory. The physical commerce module 150 may apply the one or more incentives to the product inventory for each consumer at a checkout station and/or through a redemption credit on the one or more IoT devices and/or smart wearable devices associated with the consumer.

At 212, the physical commerce module 150 monitors the one or more incentives. The physical commerce module 150 may monitor the one or more incentives utilized by the plurality of consumers and/or the results of the one or more incentives on consumer behavior.

The physical commerce module 150 may store data associated with the one or more incentives in the database 130 (e.g., knowledge corpus). The physical commerce module 150 may utilize the data received in determining at least the effectiveness of each incentive. The physical commerce module 150 may additionally utilize this data in training the one or more machine learning models for determining future incentives.

The physical commerce module 150 may additionally utilize this data in providing summaries to the user within the user interface. The physical commerce module 150 may provide a summary for each alert, which may include, inventory purchased, incentives utilized, comparable metrics to other time frames, and/or one or more recommendations. The one or more recommendations may include recommended additions or removals from essential items lists, adjustments to predetermined incentives, amongst other recommendations which may improve the performance of the physical store during uncertain events.

It may be appreciated that FIG. 2 provides only an illustration of one embodiment and do not imply any limitations with regard to how different embodiments may be implemented. Many modifications to the depicted embodiment(s) may be made based on design and implementation requirements.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

The present disclosure shall not be construed as to violate or encourage the violation of any local, state, federal, or international law with respect to privacy protection.

1. A method for store optimization, the method comprising:
monitoring a plurality of consumers for a physical store;
receiving an alert for an uncertain event, the uncertain event being associated with one or more sets of rules;
determining one or more incentives to offer the plurality of consumers using one or more machine learning models trained based on at least the one or more sets of rules associated with the received alert and one or more lists of essential items corresponding to the uncertain event;
applying the one or more incentives to a product inventory of the physical store using a tiered discount model generated by the one or more machine learning models based on at least, one or more of, a capacity of the physical store under the one or more sets of rules, a number of consumers within the physical store, and a number of consumers outside the physical store;
retraining the one or more machine learning models based on an effectiveness of the one or more incentives on the plurality of consumers; and
adjusting the tiered discount model applied to the product inventory using the one or more machine learning models retrained based on the effectiveness of the one or more incentives.

2. (canceled)

3. (canceled)

4. The method of claim 1, wherein the one or more incentives are adjusted for each of the plurality of consumers based on an elapsed time spent within the physical store, wherein the elapsed time is determined based on a time stamp associated with a consumer device corresponding to a time the consumer entered the physical store.

5. The method of claim 1, further comprising:
monitoring an effectiveness of the one or more incentives on the plurality of consumers, wherein data gathered on the effectiveness of the one or more incentives is stored in a knowledge corpus.

6. (canceled)

7. The method of claim 1, wherein monitoring the plurality of consumers for the physical store further comprises:
generating a digital twin of the physical store based on at least images, videos, or Three-Dimensional (3D) scans collected from one or more Internet of Things (IoT) devices associated with the physical store or physical attribute data provided by an authorized user through a user interface;
determining the product inventory of the physical store using the one or more IoT devices associated with the physical store or integrated inventory management software, wherein the one or more lists of the essential items are identified within the product inventory and stored in a knowledge corpus;
monitoring the number of consumers within the physical store and the number of consumers outside the physical store using at least a Global Positioning System of one or more smart wearable devices associated with the plurality of consumers or thermal imagery received from one or more IoT devices associated with the physical store.

8. A computer system for store optimization, comprising:
one or more processors, one or more computer-readable memories, one or more computer-readable tangible storage medium, and program instructions stored on at least one of the one or more tangible storage medium for execution by at least one of the one or more processors via at least one of the one or more memories, wherein the computer system is capable of performing a method comprising:
monitoring a plurality of consumers for a physical store;
receiving an alert for an uncertain event, the uncertain event being associated with one or more sets of rules;
determining one or more incentives to offer the plurality of consumers using one or more machine learning models trained based on at least the one or more sets of rules associated with the received alert and one or more lists of essential items corresponding to the uncertain event;
applying the one or more incentives to a product inventory of the physical store using a tiered discount model generated by the one or more machine learning models based on at least, one or more of, a capacity of the physical store under the one or more sets of rules, a number of consumers within the physical store, and a number of consumers outside the physical store;
retraining the one or more machine learning models based on an effectiveness of the one or more incentives on the plurality of consumers; and
adjusting the tiered discount model applied to the product inventory using the one or more machine learning models retrained based on the effectiveness of the one or more incentives.

9. (canceled)

10. (canceled)

11. The computer system of claim 8, wherein the one or more incentives are adjusted for each of the plurality of consumers based on an elapsed time spent within the physical store, wherein the elapsed time is determined based on a time stamp associated with a consumer device corresponding to a time the consumer entered the physical store.

12. The computer system of claim 8, further comprising:
monitoring an effectiveness of the one or more incentives on the plurality of consumers, wherein data gathered on the effectiveness of the one or more incentives is stored in a knowledge corpus.

13. (canceled)

14. The computer system of claim 8, wherein monitoring the plurality of consumers for the physical store further comprises:
generating a digital twin of the physical store based on at least images, videos, or Three-Dimensional (3D) scans collected from one or more Internet of Things (IoT) devices associated with the physical store or physical attribute data provided by an authorized user through a user interface;
determining the product inventory of the physical store using the one or more IoT devices associated with the physical store or integrated inventory management software, wherein the one or more lists of the essential items are identified within the product inventory and stored in a knowledge corpus;
monitoring the number of consumers within the physical store and the number of consumers outside the physical store using at least a Global Positioning System of one or more smart wearable devices associated with the plurality of consumers or thermal imagery received from one or more IoT devices associated with the physical store.

15. A computer program product for store optimization, comprising:
one or more non-transitory computer-readable storage media and program instructions stored on at least one of the one or more tangible storage media, the program instructions executable by a processor to cause the processor to perform a method comprising:
monitoring a plurality of consumers for a physical store;
receiving an alert for an uncertain event, the uncertain event being associated with one or more sets of rules;
determining one or more incentives to offer the plurality of consumers using one or more machine learning models trained based on at least the one or more sets of rules associated with the received alert and one or more lists of essential items corresponding to the uncertain event;
applying the one or more incentives to a product inventory of the physical store using a tiered discount model generated by the one or more machine learning models based on at least, one or more of, a capacity of the physical store under the one or more sets of rules, a number of consumers within the physical store, and a number of consumers outside the physical store;
retraining the one or more machine learning models based on an effectiveness of the one or more incentives on the plurality of consumers; and
adjusting the tiered discount model applied to the product inventory using the one or more machine learning models retrained based on the effectiveness of the one or more incentives.

16. (canceled)

17. (canceled)

18. The computer program product of claim 15, wherein the one or more incentives are adjusted for each of the plurality of consumers based on an elapsed time spent within the physical store, wherein the elapsed time is determined based on a time stamp associated with a consumer device corresponding to a time the consumer entered the physical store.

19. The computer program product of claim 15, further comprising:
monitoring an effectiveness of the one or more incentives on the plurality of consumers, wherein data gathered on the effectiveness of the one or more incentives is stored in a knowledge corpus.

20. (canceled)

21. (canceled)

22. The method of claim 1, wherein the alert is received using one or more content moderating techniques which automatically identify alerts that impact the physical store and the one or more sets of rules associated with the uncertain event, wherein the one or more sets of rules are extracted from a federal guideline corresponding to the uncertain event.

23. The method of claim 22, wherein the one or more incentives determined using the one or more machine learning models are designed for the physical store to operate efficiently in adherence with the federal guideline.

24. (canceled)

25. The method of claim 1, further comprising:
personalizing the one or more incentives offered to at least one of the plurality of consumers based on consumer specific data received from the at least one consumer; and
providing, on a user device, a purchasing summary to each consumer corresponding to the alert, wherein the purchasing summary includes at least a summary of inventory purchased and incentives utilized a consumer.

26. The method of claim 1, further comprising:
presenting the one or more incentives to the plurality of consumers using at least in-store visual displays or a device associated with each of the plurality of consumers, wherein the one or more incentives are displayed using a cost structure displayed on the device in response to a consumer scanning a tag associated with a product.

27. The method of claim 1, wherein the one or more incentives applied to the product inventory are displayed to a consumer on a user device using a cost structure of the tiered discount model in response to the consumer scanning a tag affixed to at least one of the essential items.

28. The method of claim 1, wherein the one or more incentives are applied to one or more essential items at a checkout station through a redemption credit associated with a consumer.

29. The computer system of claim 8, further comprising:
personalizing the one or more incentives offered to at least one of the plurality of consumers based on consumer specific data received from the at least one consumer; and
providing, on a user device, a purchasing summary to each consumer corresponding to the alert, wherein the purchasing summary includes at least a summary of inventory purchased and incentives utilized a consumer.

30. The computer program product of claim 15, further comprising:
personalizing the one or more incentives offered to at least one of the plurality of consumers based on consumer specific data received from the at least one consumer; and
providing, on a user device, a purchasing summary to each consumer corresponding to the alert, wherein the purchasing summary includes at least a summary of inventory purchased and incentives utilized a consumer.
